(19) United States
(12) Patent Application Publication
(10) Pub. No.: US 2021/0058277 A1
(43) Pub. Date: Feb. 25, 2021

(54) ORTHOGONAL FREQUENCY DIVISION MULTIPLEXING MULTIPLE-INPUT MULTIPLE-OUTPUT POWER LINE COMMUNICATION SYSTEMS

(71) Applicant: The Government of the United States of America, as represented by the Secretary of the Navy, Arlington, VA (US)

(72) Inventor: Hen-Geul Yeh, Cypress, CA (US)

(21) Appl. No.: 16/996,951

(22) Filed: Aug. 19, 2020

Related U.S. Application Data
(60) Provisional application No. 62/889,073, filed on Aug. 20, 2019.

(51) Int. Cl. H04L 25/03; H04L 5/00

(52) U.S. Cl. CPC H04L 25/03012; H04L 2025/03528; H04L 25/03159; H04L 5/0007

(57) ABSTRACT

Orthogonal frequency division multiplexing schemes are described for power line communications to combat frequency-selective fading and intersymbol interference. These orthogonal frequency division multiplexing systems may employ space-time coding and/or parallel cancellation to provide low receiver complexity, two-branch diversity, and much higher carrier-to-intercarrier-interference ratio as compared to other methods, such as self-cancellation.

### CROSS-REFERENCE TO RELATED APPLICATIONS

This application claims the benefits of U.S. Provisional Application No. 62/889,073 filed on Aug. 20, 2019, the entirety of which is incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing Navy Case #111276-US2.

### BACKGROUND

The concept of a smart grid and its importance in recent years has brought attention back to power line communication (PLC) technology, which may be used for energy management in the smart grid. Smart grid technology uses the existing power cable infrastructure for communication purposes in addition to transmitting power. PLC finds multiple applications from domestic automation to broadband access. For example, PLC may be used in forming home networks.

However, fading is a problem with PLC systems. For example, a PLC system may include a transmitter and receiver in an environment that has multiple reflectors, which may create multiple paths that a transmitted signal may propagate. Consequently, the receiver may see a superposition of multiple copies of the transmitted signal, each having traversed a different path to arrive at the receiver. This may result in an attenuation of the signal power seen at the receiver and cause temporary failure of communication due to a severe drop in the channel signal-to-noise ratio. One type of fading is frequency selective fading, which is a propagation anomaly caused by partial cancellation of a signal by itself. In this case, the signal may arrive at the receiver by at least two different paths, one of which is changing (e.g., lengthening or shortening).

OFDM is a digital communication technique recognized as a bandwidth efficient transmission one. In an OFDM system, the whole bandwidth may be divided into much smaller sub-bands while preserving orthogonality between them, using fast Fourier transform and its inverse. A motivation for this band division is to mitigate the intersymbol problems associated with wide-band transmissions available in frequency selective channels. However, OFDM is vulnerable to the loss of orthogonality among subcarriers, which results in intercarrier interference. The performance of an OFDM system may degrade significantly in this scenario.

Most studies on power line communications are focused on single-input single-output PLC. However, there is increasing interest on multiple-input multiple-output PLC, which enhances the functionality and performance of OFDM. Ideas such as smart devices and Internet of things underline the importance of broadband PLC and implementation of multiple-input multiple-output signal processing.

### SUMMARY

Orthogonal frequency division multiplexing schemes are described for power line communications to combat frequency-selective fading and intersymbol interference. These OFDM systems may employ space-time coding and/or parallel cancellation to provide low receiver complexity, two-branch diversity, and much higher carrier-to-intercarrier-interference ratio as compared to other methods, such as self-cancellation.

An orthogonal frequency division multiplexing system for multiple-input multiple-output power line communications is described. This system includes, on the transmitter side, a space-time encoder configured to encode a sequence of data symbols to generate a first code word and a second code word; a first transmitter inverse transform block configured to inverse transform the first code word into an inverse transformed first code word; a second transmitter inverse transform block configured to inverse transform the second code word into an inverse transformed second code word; a first cyclic prefix adder configured to add a first cyclic prefix to the inverse transformed first code word to generate a first signal for transmitting over a first path of a power line channel; and a second cyclic prefix adder configured to add a second cyclic prefix to the inverse transformed second code word to generate a second signal for transmitting over a second path of the power line channel. The system further includes, on the receiver side, a cyclic prefix remover configured to remove the first cyclic prefix from the first signal received via the first path of the power line channel to generate a first resultant signal, and to remove the second cyclic prefix from the second signal received via the second path of the power line channel to generate a second resultant signal; a receiver forward transform block configured to simultaneously demodulate the first resultant signal and second resultant signal to respectively generate a first received signal and a second received signal; a combiner configured to combine the first received signal and the second received signal to form a combined received signal; and a detector configured to detect the data symbols from the combined received signal to form an output signal.

Another orthogonal frequency division multiplexing system for multiple-input multiple-output power line communications is described. This system includes, on the transmitter side, a space-time encoder configured to encode a sequence of data symbols to generate a first code word and a second code word; a first transmitter inverse transform block configured to inverse transform the first code word into an inverse transformed first code word; a second transmitter inverse transform block configured to inverse transform the second code word into an inverse transformed second code word; a first cyclic prefix adder configured to add a first cyclic prefix to the inverse transformed first code word to generate a first signal for transmitting over a first path of a power line channel; a second cyclic prefix adder configured to add a second cyclic prefix to the inverse transformed second code word to generate a second signal for transmitting over a second path of the power line channel. The system further includes, on the receiver side, a first cyclic prefix remover configured to remove the first cyclic prefix from the first signal received via the first path of the power line channel to generate a first resultant signal; a second cyclic prefix remover configured to remove the second cyclic prefix from the second signal received via the second path of the power line channel to generate a second resultant signal; a receiver first forward transform block configured to forward transform the first resultant signal into a first received signal; a receiver second forward transform block configured to forward transform the second resultant signal into a second received signal; a combiner configured to combine the first received signal and the second received signal to form a combined received signal; and a detector configured to detect the data symbols from the combined received signal to form an output signal.

Yet another orthogonal frequency division multiplexing system for multiple-input multiple-output power line communications is described. The system includes, on the transmitter side, a space-time encoder configured to encode a sequence of data symbols to generate a first code word and a second code word; a transmitter inverse transform block configured to inverse transform the first code word into an inverse transformed first code word; a transmitter forward transform block configured to forward transform the second code word into a forward transformed second code word; a first cyclic prefix adder configured to add a first cyclic prefix to the inverse transformed first code word to generate a first signal for transmitting over a first path of a power line channel; and a second cyclic prefix adder configured to add a second cyclic prefix to the forward transformed second code word to generate a second signal for transmitting over a second path of the power line channel. The system further includes, on the receiver side, a first cyclic prefix remover configured to remove the first cyclic prefix from the first signal received via the first path of the power line channel to generate a first resultant signal; a second cyclic prefix remover configured to remove the second cyclic prefix from the second signal received via the second path of the power line channel to generate a second resultant signal; a receiver forward transform block configured to forward transform the first resultant signal into a first received signal; a receiver inverse transform block configured to inverse transform the second resultant signal into a second received signal; a combiner configured to combine the first received signal and the second received signal to form a combined received signal; and a detector configured to detect the data symbols from the combined received signal to form an output signal.

The OFDM systems above may further include a first coupler configured to enable the first signal and the second signal to be respectively transmitted via the first path and the second path of the power line channel; and a second coupler configured to enable the first signal and the second signal to be respectively received via the first path and the second path of the power line channel. In an embodiment, first coupler may include a delta coupler that is configured to enable the first signal to be transmitted via a phase-protective earth port and the second signal to be transmitted via a phase-neutral port. The second coupler may include a star coupler configured to enable the first signal to be received via a phase port and the second signal to be received via a neutral port or a common mode port.

Further features and advantages of the invention, as well as the structure and operation of various embodiments are described in detail below with reference to the accompanying drawings.

### BRIEF DESCRIPTION OF THE DRAWINGS

FIG. 1 is a circuit diagram of a Delta-style coupler.

FIG. 2 is a circuit diagram a Star-style coupler.

FIG. 3 depicts plots of correlation between two different MIMO paths.

FIG. 4 depicts a Gilbert-Elliot model for impulse noise.

FIG. 5 is a block diagram of a 2×1 space-time orthogonal frequency division multiplexing (ST-OFDM) transceiver.

FIG. 6 is a block diagram of a 2×2 ST-OFDM transceiver.

FIG. 7 is a block diagram of a 2×2 space-time parallel cancellation orthogonal frequency division multiplexing (STPC-OFDM) transceiver.

FIG. 8 depicts plots of autocorrelation for two different MIMO paths.

FIG. 9 is a plot of a signal-to-interference ratio comparison for STPC-OFDM with various subcarriers.

FIG. 10 is a plot of a signal-to-interference ratio comparison between STPC-OFDM and ST-OFDM.

FIG. 11 is a plot of channel capacity for varying frequency offset in STPC-OFDM and ST-OFDM.

FIG. 12 is a plot of MIMO PLC bit error rate (BER) performance comparison for two coupling scenarios.

FIG. 13 is another plot of MIMO PLC BER performance comparison for two coupling scenarios.

FIG. 14 is a block diagram of an example computer system in which embodiments may be implemented.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Definitions

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, it is submitted that it is within the knowledge of one skilled in the art to effect such feature, structure, or characteristic in connection with other embodiments whether or not explicitly described.

In describing and claiming the disclosed embodiments, the following terminology will be used in accordance with the definition set forth below.

As used herein, the singular forms “a,” “an,” “the,” and “said” do not preclude plural referents, unless the content clearly dictates otherwise.

As used herein, the term “and/or” includes any and all combinations of one or more of the associated listed items.

As used herein, the term “about” or “approximately” when used in conjunction with a stated numerical value or range denotes somewhat more or somewhat less than the stated value or range, to within a range of ±10% of that stated.

Terminology used herein should not be construed as being “means-plus-function” language unless the term “means” is expressly used in association therewith.

### Overview

PLC offer a convenient and inexpensive solution due to the fact that no new wires are needed for data communications as PLC technologies can leverage the ubiquitous infrastructure of the electric power systems. In addition, the availability of power outlets in every modern building and the simplicity of installation give PLC an advantage over other “last mile” technologies, such as digital subscriber line (DSL), wireless local loop (WLL), wireless local area networks (WLANs). Most available PLC systems provide a maximum data rate of more than several megabits per second. However, the power grid may be a hostile medium for data transmission, as it was not originally designed for such purpose. Rather, the power grid was designed for the distribution of electrical power in the frequency range of 50-60 Hz. Impedance variations and mismatches, various forms of noise (e.g., impulsive noise) and narrowband interference, multipath propagation phenomena, high attenuation and other barriers of the medium are some issues that make it challenging to transmit data over the power grid.

With the problem of frequency selective multipath fading, OFDM is an effective method to mitigate such effect. Thus, multicarrier schemes may be used for PLC systems to combat frequency-selective fading and intersymbol interference (ISI). ISI is an unavoidable consequence of an OFDM communication system where the received signals become elongated and smeared into each other. To mitigate ISI, a cyclic prefix/guard time may be used for each OFDM symbol. Space-time (ST) coding is a coding-modulation technique for multiple emitting and receiving antennas/points that exploits spatial diversity created by signals transmitted through different paths. ST coding combines temporal and spatial diversity in order to provide less attenuated replicas of a transmitted signal to a receiver and thus mitigates the destructive effects of attenuation. A combination of ST coding and OFDM architectures that improve the performance of PLC systems under background and abrupt periodic and aperiodic impulse noise.

OFDM is susceptible to the imperfect orthogonality among its subcarriers caused by the frequency offset at the receiver. The loss of orthogonality may result in intercarrier interference (ICI). Parallel cancellation (PC) is a method that may be extended to ST coding to form a STPC-OFDM system that combats the ICI effect and provides a low receiver complexity, two-branch diversity, and much higher carrier-to-ICI ratio compared to other methods, such as self-cancellation, which comes at the cost of reduced data rate.

Compared to the wireless channels, the wired communication channels in a PLC system enjoy the advantage of improved performance without the cost in terms of system capacity. ST-OFDM 2×1, ST-OFDM 2×2, and STPC-OFDM 2×2 architectures in power line communications are described herein. In these architectures, the ICI is reduced by swapping fast Fourier transform (FFT) and inverse fast Fourier transform (IFFT) in upper and lower branches while using the same frequency in 2×1 and 2×2 architectures for the transmitter and the receiver. Thus, the bit error rate and the channel capacity are both improved in these architectures. The PLC systems employing these architectures are simpler and more efficient compared to those in wireless radio channels due to the elimination of time division multiplex (i.e., Mux/Demux) needed at the transmitter and the receiver for two-path ICI cancellation schemes. Time division multiplex is needed in wireless systems to ensure that there is no interference between the two parallel branches of the STPC design. However, in PLC, such requirement does not exist. Therefore, higher capacity may be achieved as a result. The STPC-OFDM in PLC design simplifies the detector, which translates into less complexity and lower cost for the transceiver.

### MIMO PLC Channel Model

In a basic digital communication system, a digital signal may be processed by a transmitter and is propagated along a transmission line/channel to a receiver, which processes the received signal and generates an output signal. In the PLC domain, the channel may be viewed as a multipath environment, where a transmitted signal arrives at the receiver through a number of paths, rather than a direct path, and may undergo different delays and attenuation. A multipath fading frequency response of the linear and time invariant single-input single-output (SISO) PLC channel may be modeled as follows:

$$H ( f ) = {\sum }_{i = 1}^{{N}_{p}} {g}_{i} {e}^{- ( {a}_{0} + {a}_{1} {f}^{γ} ) {d}_{i}} {e}^{- j 2 π f {τ}_{i}} \qquad ( 1 )$$

where Nₚ is the number of paths; a₀ and a₁ are the attenuation parameters; γ is the attenuation factor exponent; dᵢ is the distance of the ith path; gᵢ is the real fixed weight factor for the ith path; τᵢ=dᵢ/vₚ is the time delay of the ith path; and vₚ is the wave propagation velocity in the medium. The fixed coefficient gᵢ characterizes each transmitted/reflected wave component along the propagation path.

However, it has been shown that correlation exists between different paths in MIMO power line branches. Accordingly, the amplitude of channel frequency response is log-normally distributed and the phase is uniformly distributed between [−π, π]. One top-down model for MIMO-PLC has been developed that is based on the SISO-PLC model and takes into consideration the correlation. The model is expressed as follows:

$$H ( f ) = {\sum }_{i = 1}^{{N}_{p}} {g}_{i} {e}^{- j {φ}_{i}} {e}^{- ( {a}_{0} + {a}_{1} {f}^{γ} ) {d}_{i}} {e}^{- j 2 π f {τ}_{i}} \qquad ( 2 )$$

where ϕᵢ is a random phase contribution and other parameters are similar to those in (1).

In the wireless domain, a MIMO system may employ multiple transmitting and receiving antennas. In the PLC domain, MIMO transmission may be established by leveraging the presence of multiple conductors. For example, the power network in a home includes three wires: the phase, the neutral and the protective earth wires. Thus, couplers may be used to connect the communications equipment (e.g., transceivers) to the power line.

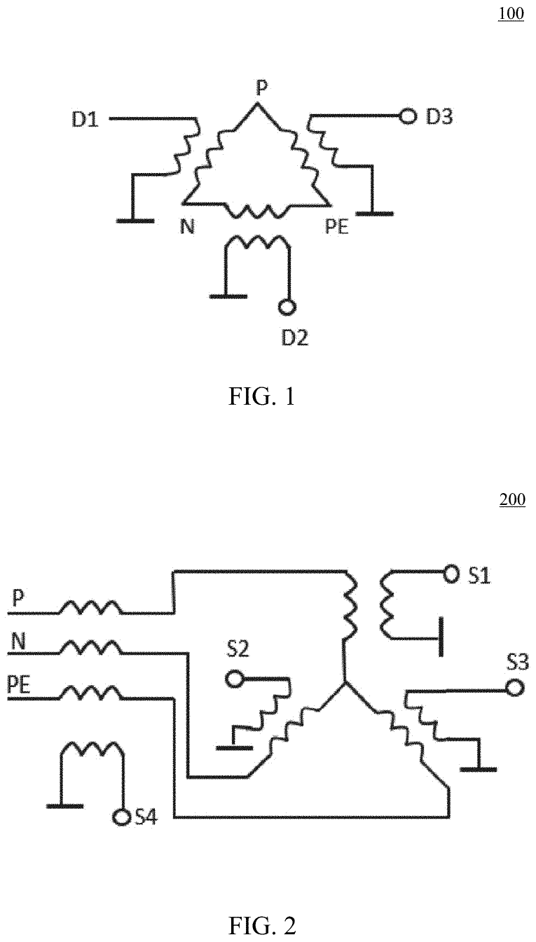

FIG. 1 is a circuit diagram of a Delta-style coupler 100, which may be utilized for MIMO-PLC. As shown in FIG. 1, coupler 100 has three differential ports available, i.e., D1 for phase-neutral (PN), D2 for neutral-protective earth (NE), and D3 for protective earth-phase (PE). Coupler 100 may be used at the transmitter of a MIMO-PLC system, where the differential signal may be injected between the pairs of wires at the available ports, resulting in three different signals in Delta mode. Due to Kirchhoff's laws, only two delta signals may be injected at the same time.

FIG. 2 is a circuit diagram of a Star-style coupler 200, which may also be utilized for MIMO-PLC. As shown in FIG. 2, coupler 200 has four ports: S1 for Phase port, S2 for neutral (N), S3 for protective earth (E), and S4 for common mode (CM). Coupler 200 may be used at the receiver of a MIMO-PLC system. Due to Kirchhoff's law, only three receiving ports have independent signals as the fourth signal collected by coupler 200 is linearly dependent on the other three signals.

Accordingly, in a system where Delta-style coupler 100 is utilized at the transmitter and Star-style coupler 200 is utilized at the receiver, a maximum of 2×3 MIMO channels may be employed. While multiple configurations are available, the 2×1 and 2×2 scenarios are described herein. Although two couplers have been described in reference to FIGS. 1 and 2, other couplers (e.g., T, triangle, or custom) may be used at the transmitter and receiver of the transceiver systems described herein.

In the MIMO scenario, the PLC channels may be correlated due to the symmetry and wiring structure. Different levels of correlation exist among the different channels. The highest correlation values may be due to the fact that power is delivered through phase and neutral wires, which may be positioned next to each other and follow the same path from the transmitter to the receiver. Therefore, appropriate coupling techniques are needed in order to ensure that the signal is effectively injected through the PLC channel to achieve high data rates.

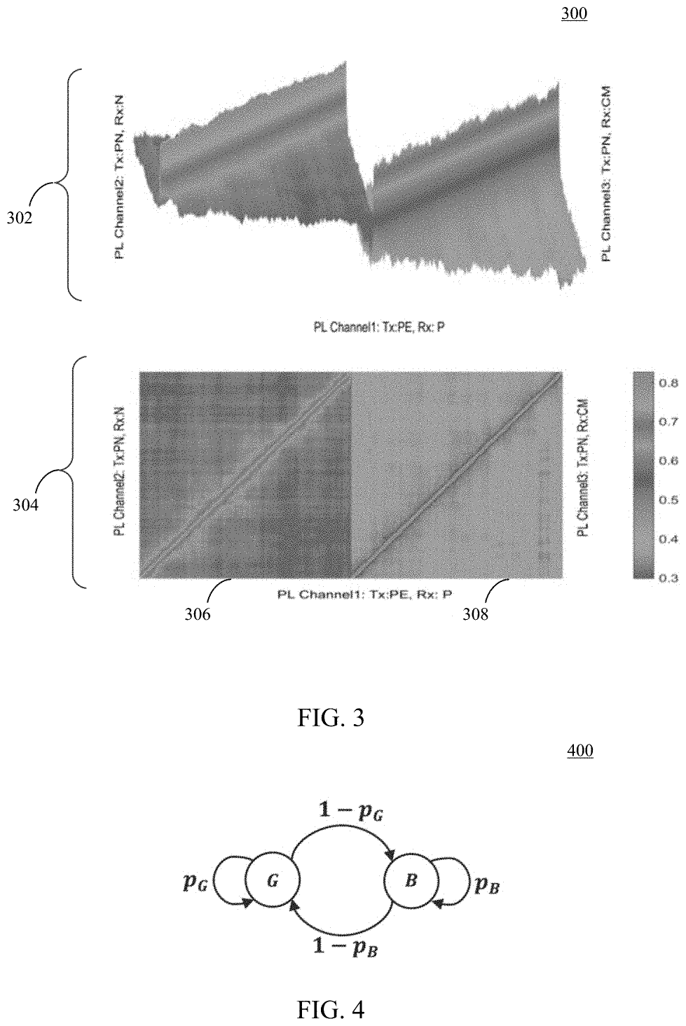

FIG. 3 depicts plots of correlation between two different MIMO paths. Subfigure 302 is a three-dimensional version of the same plot in a two-dimensional version in subfigure 204. Both axes demonstrate frequency with the range between 1.8 and 100 MHz. The horizontal axis for both parts, 306 and 308, represents a MIMO-PLC path, where a signal is applied at a Delta-style coupler (shown in FIG. 1) at the transmitter to Protective Earth (E) and Phase (P), denoted as PE (i.e., D3). At the receiver, a Star-style coupler (shown in FIG. 2) may be implemented, and the phase (P) may be used as the receiving node, i.e., S1. It is defined as power line channel 1, as shown in FIG. 3, (i.e., D3 to S1). For the vertical axes, two other paths are considered: in part 306, PNN (phase-neutral at the transmitter and neutral at the receiver, i.e., D1 to S2) and in part 308, PNCM (phase-neutral at the transmitter and common mode at the receiver, i.e., D1 to S4), which are defined as power line channels 2 and 3, respectively. The diagonal, brighter lines in subfigure 304 show the highest correlation between two paths when their operating frequency is the same. There is higher correlation between PEP-PNN versus PEP-PNCM.

The PLC channel may be a harsh, noisy environment for communication signals with high frequency and low power. Power line noise may be categorized based on temporal and spectral characteristics. Background noise and periodic and aperiodic impulse noise are classes of disturbances that signals experience in a power line. To overcome these disturbances, efforts are made to characterize and model the PLC channel with various noise characteristics. Thus, different models exist for channel noise in PLC, one of which is the additive impulsive Gaussian noise (AIGN) model that may be expressed as follows:

v(n)=v_{bkgr}(n)+vᵢₘₚ(n) (3)

Middleton's Class A (MCA) has been studied for noise amplitude and exponential distribution for interarrival time with a mean of 10.1 milliseconds. The Gilbert-Elliot model may be utilized for generating and approximating noise interarrival time and MCA for impulse noise amplitude. The occurrence of impulse noise may be determined by two states: State 1 (good state) for the background noise as an AIGN-free case and State 2 (bad state) for the case of impulsive noise. The transition matrix for this model may be expressed as follows:

$$P = [ \begin{matrix}{p}_{G} & 1 - {p}_{G} \\ 1 - {p}_{B} & {p}_{B}\end{matrix} ] = [ \begin{matrix}0.9999 & {10}^{- 5} \\ 0.2128 & 0.7872\end{matrix} ] \qquad ( 4 )$$

p_{G} is the probability of staying in the good state (background noise only) and (1−p_{G}) is the transition probability from the good state to the bad state. Similarly, p_{B} is the probability of staying in the bad state (impulse noise) and (1−p_{B}) is the transition probability from the bad state to the good state.

These probabilities determine the interarrival time and duration of the impulse noise. The average interarrival time between impulse noise is determined by p_{G}×Tₛ, where Tₛ is the sampling interval. The width of the impulse noise is also related directly to p_{B}.

MCA parameters include A=5.8 and Γ=0.1, where A is the impulsive index and Γ is referred to as the background-to-impulse noise ratio

$${p}_{a} ( x ) = {\sum }_{i = 0}^{∞} {p}_{i} 𝒩 ( 0 , {σ}_{i}^{2} ) \qquad ( 5 )$$

where

$${p}_{i} = \frac{{e}^{- A} {A}^{i}}{i !} , {σ}_{i}^{2} = ( \frac{\frac{i}{A} + Γ}{1 + Γ} ) \cdot {p}_{0} {σ}_{0}^{2}$$

is the background noise power and Σᵢ₌₁^{∞}pᵢσᵢ², are impulsive noise elements. σₐ²=Σᵢ₌₀^{∞}pᵢσᵢ² is the total noise power and background-to-impulsive noise ratio is

$$Γ = \frac{{p}_{0} {σ}_{0}^{2}}{{\sum }_{i = 1}^{∞} {p}_{i} {σ}_{i}^{2}} .$$

FIG. 4 depicts a Gilbert-Elliot model for impulse noise. This model includes two states: a good state, denoted as state “G”, represents only background noise and a bad state, denoted as state “B”, indicates the existence of impulsive noise. The transition matrix for this model is described in (4). For the case of impulsive noise, random Gaussian impulsive elements as described above may be added to background noise at the receiver.

### 2×1 Space-Time OFDM System

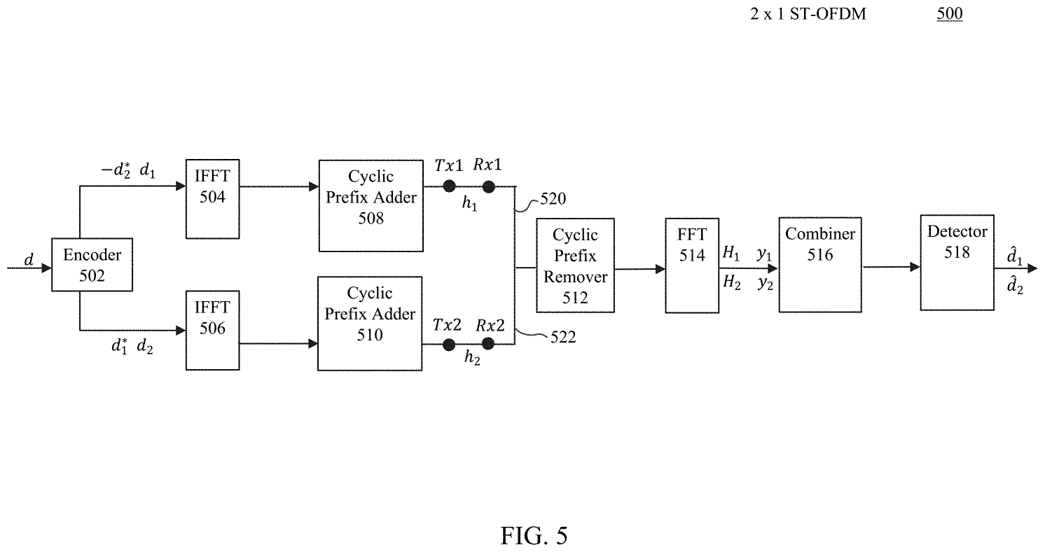

FIG. 5 is a block diagram of a 2×1 space-time orthogonal frequency division multiplexing (ST-OFDM) transceiver 500. Transceiver 500 has a parallel architecture that enables two multiplexed signals to be communicated that are then combined during reception, thereby providing improved performance in the presence of frequency offsets. Transceiver 500 may include a transmitter on the left with an encoder 502, an IFFT block 504, a cyclic prefix adder 508 on the upper branch and an IFFT block 506 and a cyclic prefix adder 510 on the lower branch. Transceiver 500 may further include a receiver on the right with a cyclic prefix remover 512, an FFT block 514, a combiner 516 and a detector 518. For the sake of brevity, transceiver 500 has been simply illustrated in FIG. 5. Transceiver 500 may include other components not shown (e.g., a scrambler, an interleaver, a mapper, a de-mapper, a de-interleaver, or de-scrambler) and components may be implemented in ways other than depicted in FIG. 5.

In an OFDM system, such as transceiver 500, an input data stream may be partitioned into N blocks of data symbols, which are communicated in a parallel format by modulating the data symbols on N orthogonal subcarriers. Accordingly, the input data stream may be mapped to a signal constellation (e.g., via phase shifted keying modulation or quadrature amplitude modulation) and the mapped symbols may be represented by a series of complex numbers in vector space. Then, the N complex numbers are grouped together and amplitude modulated onto N orthogonal subcarriers. The N modulated subcarriers may be combined to form a composite signal, an OFDM symbol. The process of mapping, grouping, modulation, and combining may continue for every N data symbols of complex numbers. Each input data stream may be communicated by frequency division across the frequency bandwidth of the communication channel. On the receiver side, OFDM symbols may be frequency demodulated using the same N subcarriers. The magnitude of the complex value associated with each of the N subcarriers may be extracted at the end of each OFDM symbol. The N complex numbers may be placed in sequential order and the input data stream may be recovered based on the signal constellation mapping. Discrete Fourier transforms (DFT) may be used for orthogonal frequency modulation, and forward fast Fourier transform (FFT) is an effective technique to implement the DFTs. Thus, an OFDM transmitter may include an IFFT and the receiver may include an FFT. The OFDM transmitter, may use the IFFT to place N parallel inputs to N orthogonal subcarriers, eventually forming an IFFT output sequence for transmitting to the receiver. The receiver performs the reverse operations to the transmitter.

Referring back to FIG. 5, two consecutive data blocks with length of N may be formed as input data d to encoder 502 at the transmitter. d includes a first data symbol, d₁, and a second data symbol, d₂, as shown below.

d₁=[d₀d₁ . . . d_{N-2}d_{N-1}]^{T}

d₂=[d_{N}d_{N+1} . . . d_{2N-2}d_{2N-1}]^{T} (6)

Encoder 502 is configured to control errors in data transmission and protect data sent over the channel. Errors introduced in the process of transmission or storage may be corrected by adding redundancy to the input data. A code word or coded sequence may be obtained by adding a redundant symbol to the information symbol. Encoder 502 may be a space-time encoder. In most scattering environments, antenna diversity is a practical method for reducing the detrimental effects of multipath fading. Space-time coding employs the idea of multiple transmitting and receiving antennas. At the transmitter, the transmitted signal may be linearly combined, while the inverse process takes place at the receiver. In the PLC environment, the implementation of space-time codes can leverage the intrinsic spatial diversity in the use of a three-phase power line network. In PLC, the wires are assumed to be completely isolated. However, in practice, there is energy transfer between the wires, due to wiring and grounding practices, which may lead to diversity gain at the receiver.

Thus, encoder 502 is configured to encode a sequence of data symbols to generate a first code word and a second code word. At time t and t+T, (d₁, d₂) and (−d₂*, d₁*) are produced, respectively. That is, encoder 502 is configured to encode input data d into two code words. In the upper branch of the transmitter, the first code word −d₂*, d₁ is passed onto IFFT block 504, where the first vector d₁ goes first (at time slot t) and then the negative conjugate of the second vector −d₂* (at time slot t+T). Similarly, in the lower branch of the transmitter, the second vector d₂ goes first and then the conjugate of the first vector d₁* is passed onto to IFFT block 506.

IFFT block 504 is configured to inverse transform the first code word into an inverse transformed first code word. IFFT block 506 is configured to inverse transform the second code word into an inverse transformed second code word. IFFT block 504 and IFFT block 506 are connected in parallel in the transmitter. The modulation and demodulation of the OFDM signal may be performed in the discrete-time domain, using two transforms, the IFFT and the FFT. By considering only one time interval, the signal to be transmitted with length T, the OFDM signal is just a Fourier synthesis for that period. With ideal synchronization between the receiver and the transmitter, the FFT may be performed on the receiver side to recover the data symbols transmitted. A Fourier analysis may be implemented through FFT in the transmitter and Fourier synthesis may be implemented by IFFT in the receiver. Accordingly, IFFT block 504 shown in FIG. 5 may be responsible for transformation of both amplitude and phase of each component of the data symbol spectrum into the time domain. Thus, the number of complex data may be converted to the same number of data in the time domain.

Cyclic prefix adder 508 is configured to add a first cyclic prefix to the inverse transformed first code word to generate a first signal for transmitting over a first path 520 of a power line channel. Cyclic prefix adder 510 is configured to add a second cyclic prefix to the inverse transformed second code word to generate a second signal for transmitting over a second path 522 of the power line channel. The paths and/or the power line channel may have characteristics as specified above with the noise modeling. When a signal is passed through a time-dispersive channel, intersymbol interference may occur and negatively impact the orthogonality between the subcarriers, thereby causing further intercarrier interference. Intersymbol interference may be overcome with the addition of a cyclic prefix, which may be a percentage copy of the last part of the OFDM symbol that is appended to the input signal before it is transmitted. For example, the cyclic prefix may be added to the start of the OFDM symbol before transmission. The cyclic prefix may be chosen to be longer than the expected delay (e.g., longer than the experienced impulse response) while accounting for its effect on the signal to noise ratio.

On the receiver side, cyclic prefix remover 512 is configured to remove the first cyclic prefix from the first signal received via the first path of the power line channel to generate a first resultant signal. Cyclic prefix remover 512 is further configured to remove the second cyclic prefix from the second signal received via the second path of the power line channel to generate a second resultant signal. That is, the percentage copy of the signal that is inserted by cyclic prefix adder 508 and cyclic prefix adder 510 may be removed by cyclic prefix remover 512 at the receiver. The resultant signals are then passed onto FFT block 514.

FFT block 514 is configured to demodulate the received signals from both branches of the transmitter. That is, FFT block 514 is configured to simultaneously forward transform the first resultant signal and the second resultant signal to respectively generate a first received signal and a second received signal. FFT block 514 may perform the reverse operations of IFFT blocks 504 and 506, converting data points from the time domain back to the frequency domain.

Assuming the channel state information (CSI) may be known at the receiver, and the channel state is constant for two consecutive time slots, the received signal vectors after FFT at time slots 1 and 2 are, respectively

y₁=H₁d₁+H₂d₂, y₂=−H₁d₂*+H₂d₁* (7)

H₁ and H₂ are two diagonal matrices with elements that are FFTs of channel impulse response of h₁ and h₂, respectively. h₁ and h₂ are impulse responses from Tx1 and Tx2 respectively related to the upper and lower branches.

Combiner 516 is configured to combine the first received signal and the second received signal provided by FFT block 514. Combiner 516 may be a coherent combiner. For example, combiner 516 may be configured to perform diversity combining of both the upper and lower branches with coherent output. Thus, combiner 516 may perform maximal ratio combining of the plurality of complex values received from FFT block 514 and the channel complex gain estimation. Combiner 516 may output a plurality of real value vectors to detector 518.

Detector 518 is configured to detect the data symbols from the combined received signal to form an output signal. For example, detector 518 may convert the output of combiner 516 into a binary stream. The output signal is shown in FIG. 5 as decision variables \hat{d}₁ and \hat{d}₂. After having passed through combiner 516 and detector 518, the decision variables may be obtained as follows:

\hat{d}₁(H₁*y₁+H₂y₂*)/(|H₁|²+|H₂|²)

\hat{d}₂(H₂*y₁−H₁y₂*)/(|H₁|²+|H₂|²). (8)

Referring back to FIGS. 1 and 2, in an embodiment, the architecture of transceiver 500 in PLC may be obtained via the following mappings between the couplers and the nodes of transceiver 500 shown in FIG. 5. For the upper branch, Tx1 may be mapped to D3 and its corresponding Rx1 node is S1. For the lower branch, two scenarios may be considered. In the first scenario, Tx2 may be mapped to D1 and Rx2 may be mapped to S2. In the second scenario, Tx2 may be mapped to D1 and Rx2 may be mapped to S4. Thus, in an embodiment where the transmitter is coupled with the Delta-style coupler and the receiver is coupled with the Star-style coupler, the Delta-style enables a first and second signals to be respectively transmitted via first path 520 and second path 522 of the power line channel. In particular, the Delta-style coupler enables the first signal to be transmitted via D3 (phase-protective earth port) and the second signal to be transmitted via D1 (phase-neutral port). The Star-style coupler enables the first signal to be received via S1 (phase port) and the second signal to be received via S2 (neutral port) or S4 (common mode port).

### 2×2 Space-Time OFDM System

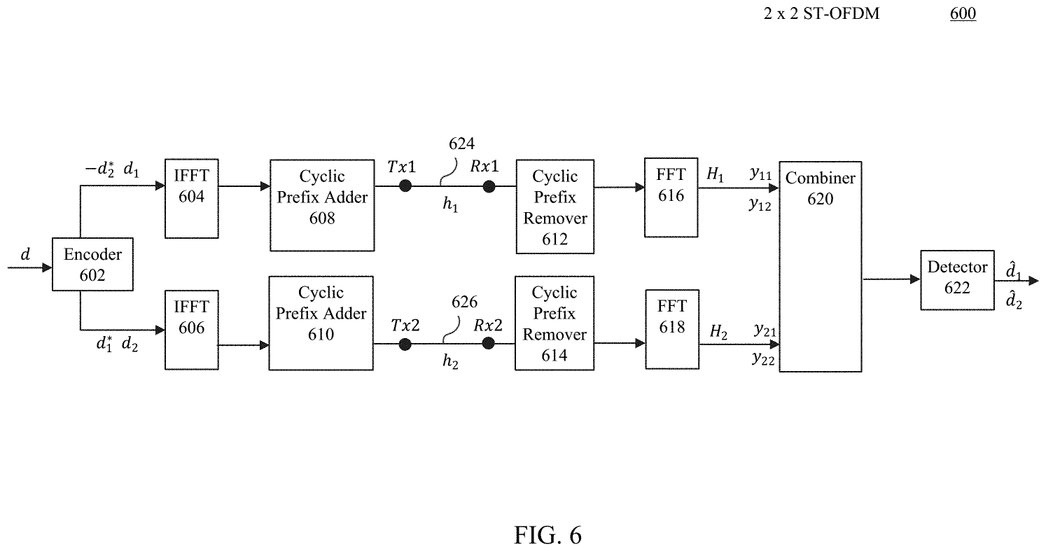

FIG. 6 is a block diagram of a 2×2 space-time orthogonal frequency division multiplexing (ST-OFDM) transceiver 600. Transceiver 600 may include a transmitter on the left with an encoder 602. Transceiver 600 may further include an IFFT block 604, a cyclic prefix adder 608 on the upper branch and an IFFT block 606 and a cyclic prefix adder 610 on the lower branch. Transceiver 600 may also include a receiver on the right with a cyclic prefix remover 612, an FFT block 616 on the upper branch, and a cyclic prefix remover 614 and an FFT block 618 on the lower branch. The receiver further includes a combiner 620 coupled to FFT blocks 616 and 618, and a detector 622 coupled with combiner 620. For the sake of brevity, transceiver 600 has been simply illustrated in FIG. 6. Transceiver 600 may include other components not shown and components may be implemented in ways other than depicted in FIG. 6.

The difference between FIG. 5 and FIG. 6 is at the receiver, where two independent branches exist for the 2×2 system (transceiver 600) instead of one branch in the 2×1 system (transceiver 500). The two transmission paths are independently separated, for example, three phase wires. The components of transceiver 600 are similar to the components of transceiver 500, therefore they may be similarly implemented as described above in reference to FIG. 5.

As show in FIG. 6, encoder 602 is configured to encode a sequence of data symbols to generate a first code word and a second code word. In an embodiment, encoder 602 is a space-time encoder. Encoder 602 is configured to respectively produce at time t and t+T, (d₁, d₂) and (−d₂*, d₁*). That is, encoder 602 is configured to encode input data d into two code words. In the upper branch of the transmitter, the first code word −d₂*, d₁ is passed onto IFFT block 604, where the first vector d₁ goes first (at time slot t) and then the negative conjugate of the second vector −d₂* (at time slot t+T). Similarly, in the lower branch of the transmitter, the second vector d₂ goes first and then the conjugate of the first vector d₁* is passed onto to IFFT block 606.

In the upper branch, IFFT block 604 is configured to inverse transform the first code word into an inverse transformed first code word. In the lower branch, IFFT block 606 is configured to inverse transform the second code word into an inverse transformed second code word. IFFT block 604 and IFFT block 606 are connected in parallel in the transmitter.

Cyclic prefix adder 608 is configured to add a first cyclic prefix to the inverse transformed first code word to generate a first signal for transmitting over a first path 624 of a power line channel. Cyclic prefix adder 610 is configured to add a second cyclic prefix to the inverse transformed second code word to generate a second signal for transmitting over a second path 626 of the power line channel. The paths and/or the power line channel may have characteristics as specified above with the noise modeling.

On the receiver side, cyclic prefix remover 612 is configured to remove the first cyclic prefix from the first signal received via the first path of the power line channel to generate a first resultant signal. Cyclic prefix remover 614 is configured to remove the second cyclic prefix from the second signal received via the second path of the power line channel to generate a second resultant signal. The first and second resultant signals are then passed onto FFT block 616 and FFT 618, respectively.

FFT block 616 is configured to forward transform the first resultant signal into a first received signal. FFT block 618 is configured to forward transform the second resultant signal into a second received signal. The first and second received signals after FFT at time slots 1 and 2 may be respectively be described as follows.

y₁₁=H₁d₁, y₁₂=−H₁d₂*

y₂₁=H₂d₂, y₂₂=H₂d₁*. (9)

The first received signal and the second received signal, the input signals to combiner 620, have notations with two subindexes in the form of yᵢₜ. The first subindex represents the receiver index “i” and the second subindex represents the time slot “t”. Since the transmitter node is connected to the receiver node directly, there is no need to indicate the transmitter node in a subindex.

Combiner 620 is configured to combine the first received signal and the second received signal provided by FFT block 616 and FFT block 618. Combiner 620 may be a coherent combiner.

Detector 622 is configured to detect the data symbols from the combined received signal to form an output signal. The output signal is shown in FIG. 6 as decision variables \hat{d}₁ and \hat{d}₂. After combiner 620 and detector 622 operations, the decision variables may be obtained as follows:

\tilde{d}₁(H₁*y₁₁+H₂y₂₂*)/(|H₁|²+|H₂|²)

\tilde{d}₂(H₂*y₂₁−H₁y₁₂*)/(|H₁|²+|H₂|²). (10)

Referring back to FIGS. 1 and 2, in an embodiment, the architecture of transceiver 600 in PLC may be obtained via the following mappings between the couplers and the nodes of transceiver 600. For the upper branch, Tx1 may be mapped to D3 and its corresponding Rx1 node is S1. For the lower branch, two scenarios may be considered. In the first scenario, Tx2 may be mapped to D1 and Rx2 may be mapped to S2. In the second scenario, Tx2 may be mapped to D1 and Rx2 may be mapped to S4. Thus, in an embodiment where the transmitter is coupled with the Delta-style coupler and the receiver is coupled with the Star-style coupler, the Delta-style enables a first and second signals to be respectively transmitted via a first path 624 and a second path 626 of the power line channel. In particular, the Delta-style coupler enables the first signal to be transmitted via D3 (phase-protective earth port) and the second signal to be transmitted via D1 (phase-neutral port). The Star-style coupler enables the first signal to be received via S1 (phase port) and the second signal to be received via S2 (neutral port) or S4 (common mode port).

### 2×2 STPC-OFDM System

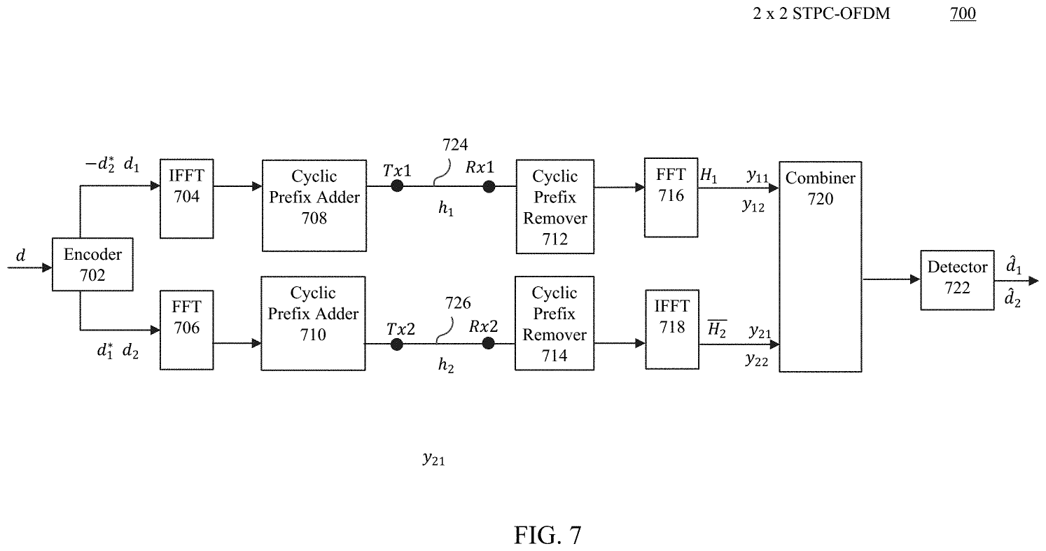

FIG. 7 is a block diagram of a 2×2 space-time parallel cancellation orthogonal frequency division multiplexing (STPC-OFDM) transceiver 700. Transceiver 700 may include a transmitter on the left and a receiver on the right. The transmitter includes encoder 702, and an IFFT block 704, a cyclic prefix adder 708 on the upper branch, and an FFT block 706 and a cyclic prefix adder 710 on the lower branch. The transmitter is configured to transmit data to the receiver over a PLC channel via a first path 724 and a second path 726. The receiver includes cyclic prefix remover 712 and an FFT bloc 716 on the upper branch, and a cyclic prefix remover 714 and an IFFT block 718 on the lower branch. The receiver further includes combiner 720 and detector 722. Transceiver 700 may include other components not shown and the configuration of the components may be different from the depiction of FIG. 1. For example, in an embodiment, transceiver 700 may include a FFT block on the upper branch in parallel to an IFFT block on the lower branch of the transmitter, and an IFFT block on the upper branch in parallel to a FFT block on the lower branch of the receiver. Furthermore, while FIGS. 5-7 show systems that include both a transmitter and a receiver, in embodiments, only a transmitter or a receiver may be implemented.

Transceiver 700 has a similar configuration as transceiver 600. In the configuration of transceiver 700, at the transmitter in the upper branch IFFT is applied while in the lower branch an FFT is implemented. Similarly, at the receiver, FFT is applied to the upper branch and IFFT is applied to the lower branch. So, the process in each branch is the reverse of the other one.

As shown in FIG. 7, encoder 702 is configured to encode a sequence of data symbols to generate a first code word and a second code word. Encoder 702 may be a space-time encoder. In an embodiment, at time t and t+T, (d₁, d₂) and (−d₂*, d₁*) are produced, respectively. That is, encoder 702 is configured to encode input data d into two code words. In the upper branch of the transmitter, the first code word −d₂*, d₁ is passed onto IFFT block 704, where the first vector d₁ goes first (at time slot t) and then the negative conjugate of the second vector −d₂* (at time slot t+T). Similarly, in the lower branch of the transmitter, the second vector d₂ goes first and then the conjugate of the first vector d₁* is passed onto to FFT block 706.

In the upper branch, IFFT block 704 is configured to inverse transform the first code word into an inverse transformed first code word. In the lower branch, FFT block 706 is configured to forward transform the second code word into a forward transformed second code word. IFFT block 704 and FFT block 706 are connected in parallel in the transmitter.

Cyclic prefix adder 708 is configured to add a first cyclic prefix to the inverse transformed first code word to generate a first signal for transmitting over a first path 724 of a power line channel. Cyclic prefix adder 710 is configured to add a second cyclic prefix to the forward transformed second code word to generate a second signal for transmitting over a second path 726 of the power line channel. The paths and/or the power line channel may have characteristics as specified above with the noise modeling.

On the receiver side, cyclic prefix remover 712 is configured to remove the first cyclic prefix from the first signal received via the first path of the power line channel to generate a first resultant signal. Cyclic prefix remover 714 is configured to remove the second cyclic prefix from the second signal received via the second path of the power line channel to generate a second resultant signal. The first and second resultant signals are then passed onto FFT block 716 and IFFT 718, respectively.

FFT block 716 is configured to forward transform the first resultant signal into a first received signal. IFFT block 718 is configured to inverse transform the second resultant signal into a second received signal. The received signal vectors after transformation of FFT block 716 and IFFT block 718 at time slots 1 and 2, respectively, may be described as follows.

y₁₁=H₁d₁, y₁₂=−H₁d₂*

y₂₁=H̅₂d₂, y₂₂=H̅₂d₁* (11)

where H₁ is a diagonal matrix whose elements are N-point FFTs of the channel response h₁ and H̅₂̅ is a diagonal matrix whose elements are N-point IFFT of channel impulse response h₂. The first received signal and the second received signal, the input signals to combiner 720, have notations with two subindexes in the form of yᵢₜ. The first subindex represents the receiver index “i” and the second subindex represents the time slot “t”. Since the transmitter node is connected to the receiver node directly, there is no need to indicate the transmitter node in a subindex.

Combiner 720 is configured to combine the first received signal and the second received signal provided by FFT block 76 and IFFT block 718. Combiner 720 may be a coherent combiner.

Detector 722 is configured to detect the data symbols from the combined received signal to form an output signal. The output signal is shown in FIG. 7 as decision variables \hat{d}₁ and \hat{d}₂. After combiner 720 and detector 722 operations, the decision variables may be obtained as follows:

\hat{d}₁(H₁*y₁₁+H̅₂y₂₂*)/(|H₁|²+|H̅₂̅|²)

\hat{d}₂(−H₁y₁₂*+H̅₂*y₂₁)/(|H₁|²+|H̅₂̅|²) (12)

In the ST-OFDM and STPC-OFDM configurations shown in FIGS. 5-7, different paths with channel frequency responses such as H₁, H₂ and H̅₂̅ are denoted. These channels are correlated as seen in FIG. 1. As described herein, a few scenarios may be considered based on the level of correlation between MIMO-PLC paths, although other scenarios may also be implemented. For example, as shown in FIG. 7, the path denoted by h₁ may be between the transmitter phase-protective earth on the Delta-style coupler and phase at the receiver in the Star-style coupler (i.e., Tx1 mapped to D3 to Rx1 mapped to S1). For the lower branch, two scenarios may be considered for the path denoted by h₂ as follows. For the first case, Tx2 may be mapped to D1 and Rx2 may be mapped to S2. For the second case, Tx2 may be mapped to D1 and Rx2 may be mapped to S4. All these different scenarios are considered as STPC-OFDM 2×2 architectures in PLC, as will be further explained below.

### ICI Cancellations of STPC-OFDM 2×2 Architecture in PLC

To maintain orthogonality without crosstalk among the subcarriers at the receiver, the demodulating carriers need to be exactly aligned with the transmitted carriers and the receiver demodulation process must take place over a period of time that is equal to the reciprocal of the subcarrier spacing. In an OFDM signal, that is a composite signal of N component signals modulated on N orthogonal subcarriers, the desired component signal should be only on the desired subcarrier of interest. However, when there is frequency offset, the signal strength at any desired subcarrier may be reduced and the signal may leak into other undesired subcarriers, causing ICI from one subcarrier to other subcarriers at the output of the FFT receiver. Consequently, the desired signal may be distorted and the BER performance is degraded.

The additional receiver IFFT in combination with the additional transmitter FFT in a PC OFDM system provides a smaller intercarrier interference cancellation on undesired subcarriers while maintaining the same signal strength on the desired subcarrier as that of the OFDM system without the parallel FFT/IFFT blocks. Thus, the additional transmitter FFT and additional receiver IFFT improves the SIR and effectively mitigates ICI.

ICI of STPC-OFDM 2×2 will be described in reference to transceiver 700, shown in FIG. 7. The complex baseband signal of the output of IFFT block 704 at the upper branch transmitter is as follows:

$${x}_{n , 1} = {\sum }_{k = 0}^{N - 1} {d}_{k , 1} {e}^{j 2 π kn \text{/} N} ; n = 0 , 1 , … , N - 1 \qquad ( 13 )$$

where d_{k,1} is the data symbol allocated to the upper branch and e^{j2πkn/N}, n=0, . . . , N−1, is corresponding to the orthogonal frequency of each OFDM subcarrier. The second subindex of x_{n,1} and d_{k,1} represents the upper branch operation.

At the receiver, the received signal is mixed with a local oscillator which is E above the carrier frequency. The received signal at the upper branch is in the form of

$${r}_{n , 1} = {x}_{n , 1} {e}^{j 2 πϵ n \text{/} N} * {h}_{n , 1} + {w}_{n , 1} \qquad ( 14 )$$

where ϵ represents the normalized frequency offset of the received signal with respect to subcarrier spacing, * represents the convolution, and w_{n,1} is the sum of AIGN and additive white Gaussian noise (AWGN) experienced in the upper branch.

The signal obtained at the output of FFT 716, at the receiver at the upper branch, is as follows.

$$\begin{matrix}{\hat{d}}_{k , 1} = \frac{1}{N} {\sum }_{n = 0}^{N - 1} {r}_{n , 1} {e}^{- j π kn \text{/} N} + {W}_{k , 1} \\ = \frac{1}{N} {\sum }_{n = 0}^{N - 1} {\sum }_{m = 0}^{N - 1} {d}_{m , 1} {H}_{m , 1} {e}^{\frac{j 2 π ( m - k + ϵ ) n}{N}} + {W}_{k , 1} \\ = \frac{1}{N} {\sum }_{m = 0}^{N - 1} {d}_{m , 1} {H}_{m , 1} {\sum }_{n = 0}^{N - 1} {e}^{\frac{j 2 π ( m - k + ϵ ) n}{N}} + {W}_{k , 1}\end{matrix} \qquad ( 15 )$$

where H_{m,1} is the mth subcarrier of N-point FFT of the channel impulse response of the upper branch h₁=[h_{0,1}, h_{1,1}, . . . , h_{L-1,1}, 0, . . . , 0]^{T} with N−L padded zeros and W_{k,1} being the FFT of the sum of AIGN and AWGN noise.

Knowing that

$${\sum }_{k = 0}^{N - 1} {α}^{k} = \frac{1 - {α}^{N}}{1 - α} . \qquad ( 16 )$$

Without loss of generality, AIGN and AWGN are considered to be zero to demonstrate the ICI-reduction technique. Equation (15) may be simplified to the following:

$$\begin{matrix}\begin{matrix}{\hat{d}}_{k , 1} = \frac{1}{N} {\sum }_{m = 0}^{N - 1} {d}_{m , 1} {H}_{m , 1} \frac{1 - {e}^{j 2 π ( m - k + ϵ )}}{1 - {e}^{j 2 π ( m - k + ϵ ) \text{/} N}} \\ = \frac{1}{N} {\sum }_{m = 0}^{N - 1} {d}_{m , 1} {H}_{m , 1} \frac{{e}^{j π ( m - k + ϵ )}}{{e}^{j π ( m - k + ϵ ) \text{/} N}} \frac{sin [ π ( m - k + ϵ ) ]}{sin [ \frac{π}{N} ( m - k + ϵ ) ]} \\ = {d}_{k , 1} {H}_{k , 1} {U}_{0} + {\sum }_{m = 0 , m \neq k}^{N - 1} {d}_{m , 1} {H}_{m , 1} {U}_{m - k}\end{matrix} \\ where & ( 17 ) \\ {U}_{m - k} = \frac{1}{N} {e}^{\frac{j π ( N - 1 )}{N} ( n - k + ϵ )} \frac{sin [ π ( m - k + ϵ ) ]}{sin [ \frac{π}{N} ( m - k + ϵ ) ]} & ( 18 )\end{matrix}$$

A similar process may be used for the lower branch, where FFT is implemented at the transmitter and IFFT is implemented at the receiver.

$${x}_{n , 2} = \frac{1}{N} {\sum }_{k = 0}^{N - 1} {d}_{k , 2} {e}^{- j 2 π kn \text{/} N} ; n = 0 , 1 , … , N - 1 \qquad ( 19 )$$

The output of IFFT block 718 at the lower branch of the receiver may be expressed as follows.

$$\begin{matrix}{\hat{d}}_{k , 2} = \frac{1}{N} {\sum }_{n = 0}^{N - 1} {r}_{n , 2} {e}^{j 2 π kn \text{/} N} \\ = \frac{1}{N} {\sum }_{n = 0}^{N - 1} {\sum }_{m = 0}^{N - 1} {d}_{m , 2} {\overline{H}}_{m , 2} {e}^{\frac{j 2 π ( - m + ϵ ) n}{N}} {e}^{\frac{j 2 π kn}{N}} \\ = \frac{1}{N} {\sum }_{m = 0}^{N - 1} {d}_{m , 2} {\overline{H}}_{m , 2} \frac{1 - {e}^{j 2 π ( k - m + ϵ )}}{1 - {e}^{j 2 π ( k - m + ϵ ) \text{/} N}}\end{matrix} \qquad ( 20 )$$

where d_{m,2} is the data symbol transmitted at the lower branch of FIG. 6 and H̅_{m,2} is the mth subcarrier of N-point IFFT of channel impulse response h_{m,2}=[h_{0,2}, h_{1,2}, . . . , h_{L-1,2}, 0, . . . , 0]^{T} with N−L padded zeros.

Using the same method shown in equations (15)-(18), the following can be obtained for the lower branch:

$$\begin{matrix}{\hat{d}}_{k , 2} = {d}_{k , 2} {\overline{H}}_{k , 2} {U}_{0} + {\sum }_{m = 0 , m \neq k}^{N - 1} {d}_{m , 2} {\overline{H}}_{m , 2} {U}_{k - m} \\ where & ( 21 ) \\ {U}_{k - m} = \frac{1}{N} {e}^{\frac{j π ( N - 1 )}{N} ( k - m + ϵ )} \frac{sin [ π ( k - m + ϵ ) ]}{sin [ \frac{π}{N} ( k - m + ϵ ) ]} & ( 22 )\end{matrix}$$

At the final stage of the receiver, as shown in FIG. 7, \hat{d}_{k,1} and \hat{d}_{k,2} are combined coherently

\hat{d}ₖ=\hat{d}_{k,1}+\hat{d}_{k,2}. (23)

If the input at the upper and the lower branches are equal, d_{k,1}=d_{k,2}=dₖ, the detected signal at the output of detector 772 becomes

$${\hat{d}}_{k} = ( {H}_{k , 1} {U}_{0} + {\overline{H}}_{k , 2} {U}_{0} ) {d}_{k} + {\sum }_{m = 0 , m \neq k}^{N - 1} {d}_{m , 1} {H}_{m , 1} {U}_{m - k} + {d}_{m , 2} {\overline{H}}_{m , 2} {U}_{k - m} . \qquad ( 24 )$$

The first term in equation (24) above is the desired signal and the second term is the ICI component.

The SIR is defined as the ratio of the desired signal's power to the ICI signal's power

$$\begin{matrix}{SIR}_{k} = \frac{{P}_{s , k}}{{P}_{ICI , k}} ; k = 0 , 1 , … , N - 1 \\ where & ( 25 ) \\ {P}_{s , k} = {R}_{ss} ( 0 ) = 𝔼 [ \vert {s}^{2} \vert ] = 𝔼 [ {\vert ( {H}_{k , 1} {U}_{0} + {\overline{H}}_{k , 2} {U}_{0} ) {d}_{k} \vert}^{2} ] \\ and & ( 26 ) \\ {P}_{ICI , k} = 𝔼 [ {\sum }_{m = 0 , m \neq k}^{N - 1} {\vert {d}_{m , 1 } {H}_{m , 1} {U}_{m - k} + {d}_{m , 2} {\overline{H}}_{m , 2} {U}_{k - m} \vert}^{2} ] & ( 27 )\end{matrix}$$

Rₛₛ(τ) is the autocorrelation (ACF) of the desired signal, which is related to the power of the desired signal when τ=0. Knowing that data symbols and channels are independent

[symbol]

[H_{m,i}dₘ]= [symbol] [H_{m,i}] [symbol] [dₘ] (28)

Assuming data symbols have zero mean and are statistically independent

$$𝔼 [ {d}_{k} {d}_{m}^{*} ] = {E}_{s} {δ}_{km} = \{ \begin{matrix}{E}_{s} ; & k = m \\ 0 ; & k \neq m\end{matrix} \qquad ( 29 )$$

where Eₛ is the average energy of the data symbol.

Equation (26) may be further simplified by expanding it and implementing the independent nature of channel transfer function and data symbols.

$$\begin{matrix}{P}_{s , k} = {E}_{s} 𝔼 [ {\vert ( {H}_{k , 1} {U}_{0} + {\overline{H}}_{k , 2} {U}_{0} ) \vert}^{2} ] 𝔼 [ {\vert {d}_{k} \vert}^{2} ] \\ = {E}_{s} 𝔼 [ {\vert {U}_{0} \vert}^{2} {\vert ( {H}_{k , 1} + {\overline{H}}_{k , 2} ) \vert}^{2} ] \\ = \frac{{E}_{s} {sin}^{2} ( πϵ )}{{N}^{2} {sin}^{2} ( \frac{πϵ}{N} )} 𝔼 [ {\vert {H}_{k , 1} \vert}^{2} + {\vert {\overline{H}}_{k , 2} \vert}^{2} + {H}_{k , 1} {\overline{H}}_{k , 2}^{*} + {H}_{k , 1}^{*} {\overline{H}}_{k , 2} ] \\ = \frac{{E}_{s} {sin}^{2} ( πϵ )}{{N}^{2} {sin}^{2} ( \frac{πϵ}{N} )} [ {R}_{{H}_{1}} ( k , k ) + {R}_{{\overline{H}}_{2}} ( k , k ) + {R}_{{H}_{1} {\overline{H}}_{2}} ( k , k ) + {R}_{{\overline{H}}_{2} {H}_{1}} ( k , k ) ]\end{matrix} \qquad ( 30 )$$

where R_{H}_{₁}_{H̅}_{₂} (k, m) is the cross correlation function (CCF) between H_{k,1} and H̅_{m,2}

R_{H}_{₁}_{H̅}_{₂}(k,m)= [symbol] [H_{k,1}H̅_{m,2}*] (31)

and R_{H}_{₁} (k, m) and R_{H̅}_{₂} (k, m) are the autocorrelation of upper and lower channels for subcarrier frequencies k and m, respectively.

$$\{ \begin{matrix}{R}_{{H}_{1}} ( k , m ) = E [ {H}_{k , 1} {H}_{m , 1}^{*} ] \\ {R}_{{\overline{H}}_{2}} ( k , m ) = E [ {\overline{H}}_{k , 2} {\overline{H}}_{m , 2}^{*} ]\end{matrix} \qquad ( 32 )$$

Knowing the fact that

$$\begin{matrix}{R}_{{H}_{1} {\overline{H}}_{2}} ( k , m ) = 𝔼 [ {H}_{k , 1} {\overline{H}}_{m , 2}^{*} ] \\ = 𝔼 [ {( {H}_{k , 1}^{*} {\overline{H}}_{m , 2} )}^{*} ] = {( 𝔼 [ {\overline{H}}_{m , 2} {H}_{k , 1}^{*} ] )}^{*} \\ = {R}_{{\overline{H}}_{2} {H}_{1}}^{*} ( m , k )\end{matrix} \qquad ( 33 )$$

and using equation (33) in equation (30)

$${P}_{s , k} = \frac{{E}_{s} {sin}^{2} ( πϵ )}{{N}^{2} {sin}^{2} ( \frac{πϵ}{N} )} [ {R}_{{H}_{1}} ( k , k ) + {R}_{{\overline{H}}_{2}} ( k , k ) + 2 Re \{ {R}_{{H}_{1} {\overline{H}}_{2}} ( k , k ) \} ] \qquad ( 34 )$$

A similar process may be developed for ICI power calculations as follows:

$$\begin{matrix}{P}_{ICI , k} = & {\sum }_{m = 0 , m \neq k}^{N - 1} 𝔼 [ {\vert ( {H}_{m , 1} {U}_{m - k} + {\overline{H}}_{m , 2} {U}_{k - m} ) {d}_{m} \vert}^{2} ] \\ = & {E}_{s} {\sum }_{m = 0 , m \neq k}^{N - 1} 𝔼 [ {\vert ( {H}_{m , 1} {U}_{m - k} + {\overline{H}}_{m , 2} {U}_{k - m} ) \vert}^{2} ] \\ = & {E}_{s} {\sum }_{m = 0 , \\ m \neq K}^{N - 1} 𝔼 [ \vert ( {H}_{m , 1} \frac{1}{N} {e}^{\frac{j π ( N - 1 )}{N} ( m - k + ϵ )} \frac{sin [ π ( m - k + ϵ ) ]}{sin [ \frac{π}{N} ( m - k + ϵ ) ]} + \\ & { {\overline{H}}_{m , 2} \frac{1}{N} {e}^{\frac{j π ( N - 1 )}{N} ( k - m + ϵ )} \frac{sin [ π ( k - m + ϵ ) ]}{sin [ \frac{π}{N} ( k - m + ϵ ) ]} ) \vert}^{2} ]\end{matrix} \qquad ( 35 )$$

Defining v=m−k

$${P}_{ICI , k} = \frac{{E}_{s}}{{N}^{2}} {\sum }_{m = 0 , m \neq k}^{N - 1} 𝔼 [ {\vert ( {H}_{m , 1} {e}^{\frac{j π ( N - 1 )}{N} v} \frac{sin [ π ( v + ϵ ) ] sin [ \frac{π}{N} ( - v + ϵ ) ]}{sin [ \frac{π}{N} ( v + ϵ ) ] sin [ \frac{π}{N} ( - v + ϵ ) ]} + {\overline{H}}_{m , 2} {e}^{- \frac{j π ( N - 1 )}{N} v} \frac{sin [ \frac{π}{N} ( v + ϵ ) ] sin [ π ( - v + ϵ ) ]}{sin [ \frac{π}{N} ( v + ϵ ) ] sin [ \frac{π}{N} ( - v + ϵ ) ]} ) \vert}^{2} ] \qquad ( 36 )$$

Using a trigonometric identity, sin α sin β=½[cos(α−β)−cos(α+β)], equation (36) may be reorganized as follows.

$${P}_{ICI , k} = \frac{{E}_{s}}{{N}^{2}} {\sum }_{m = 0 , \\ m \neq k}^{N - 1} 𝔼 [ {\vert ( {H}_{m , 1} {e}^{\frac{j π ( N - 1 )}{N} v} \frac{sin ( πϵ ) sin [ \frac{π}{N} ( - v + ϵ ) ]}{\frac{1}{2} cos ( \frac{2 π v}{N} ) - \frac{1}{2} cos ( \frac{2 πϵ}{N} )} + {\overline{H}}_{m , 2} {e}^{- \frac{j π ( N - 1 )}{N} v} \frac{sin ( πϵ ) sin [ \frac{π}{N} ( v + ϵ ) ]}{\frac{1}{2} cos ( \frac{2 π v}{N} ) - \frac{1}{2} cos ( \frac{2 πϵ}{N} )} ) \vert}^{2} ] \qquad ( 37 )$$

where the following equations have been used knowing that v is an integer:

$$\begin{matrix}\{ \begin{matrix}sin [ π ( v + ϵ ) ] = {( - 1 )}^{v} sin ( πϵ ) \\ sin [ π ( - v + ϵ ) ] = {( - 1 )}^{v} sin ( πϵ )\end{matrix} \\ and & ( 38 ) \\ \{ \begin{matrix}{e}^{- \frac{j π ( N - 1 )}{N} v} = {e}^{- j π v} {e}^{\frac{j π v}{N}} = {( - 1 )}^{v} {e}^{\frac{j π v}{N}} \\ {e}^{\frac{j π ( N - 1 )}{N} v} = {e}^{j π v} {e}^{- \frac{j π v}{N}} = {( - 1 )}^{v} {e}^{- \frac{j π v}{N}}\end{matrix} & ( 39 ) \\ {P}_{ICI , k} = \frac{{E}_{s}}{{N}^{2}} {sin}^{2} πϵ {\sum }_{m = 0 , m \neq k}^{N - 1} 𝔼 [ {\vert ( {H}_{m , 1} {e}^{- \frac{j π v}{N}} \frac{sin [ \frac{π}{N} ( - v + ϵ ) ]}{\frac{1}{2} cos \frac{2 π v}{N} - \frac{1}{2} cos \frac{2 πϵ}{N}} + {\overline{H}}_{m , 2} {e}^{\frac{j π v}{N}} \frac{sin [ \frac{π}{N} ( v + ϵ ) ]}{\frac{1}{2} cos \frac{2 π v}{N} - \frac{1}{2} cos \frac{2 πϵ}{N}} ) \vert}^{2} ] & ( 40 )\end{matrix}$$

The derivation in equation (40) may be simplified further by adopting the approximations for the small value of E as follows:

$$\{ \begin{matrix}sin \frac{πϵ}{N} \approx \frac{πϵ}{N} \\ cos \frac{πϵ}{N} \approx cos \frac{2 πϵ}{N} \approx 1\end{matrix} \qquad ( 41 )$$

Using trigonometric identifies and the approximations in (41)

$$\begin{matrix}\begin{matrix}{P}_{ICI , k} = & \frac{{E}_{s}}{{N}^{2}} {sin}^{2} ( πϵ ) {\sum }_{m = 0 , \\ m \neq k}^{N - 1} 𝔼 [ \vert ( {H}_{m , 1} {e}^{- \frac{j π v}{N}} \frac{- sin \frac{π v}{N} cos \frac{πϵ}{N} + sin \frac{πϵ}{N} cos \frac{π v}{N}}{\frac{1}{2} cos \frac{2 π v}{N} - \frac{1}{2} cos \frac{2 πϵ}{N}} + \\ & { {\overline{H}}_{m , 2} {e}^{\frac{j π v}{N}} \frac{sin \frac{π v}{N} cos \frac{πϵ}{N} + sin \frac{πϵ}{N} cos \frac{π v}{N}}{\frac{1}{2} cos \frac{2 π v}{N} - \frac{1}{2} cos \frac{2 πϵ}{N}} ) \vert}^{2} ]\end{matrix} & ( 42 ) \\ = \frac{{E}_{s}}{{N}^{2}} {sin}^{2} ( πϵ ) {\sum }_{m = 0 , \\ m \neq k}^{N - 1} 𝔼 [ ( {\vert {H}_{m , 1} \vert}^{2} \frac{{( \frac{πϵ}{N} cos \frac{π v}{N} - sin \frac{π v}{N} )}^{2}}{{( \frac{1}{2} cos \frac{2 π v}{N} - \frac{1}{2} )}^{2}} + {\vert {\overline{H}}_{m , 2} \vert}^{2} \frac{{( \frac{πϵ}{N} cos \frac{π v}{N} + sin \frac{π v}{N} )}^{2}}{{( \frac{1}{2} cos \frac{2 π v}{N} - \frac{1}{2} )}^{2}} + 2 {H}_{m , 1} {\overline{H}}_{m , 2} \frac{{( \frac{πϵ}{N} )}^{2} {cos}^{2} \frac{π v}{N} - {sin}^{2} \frac{π v}{N}}{{( \frac{1}{2} cos \frac{2 π v}{N} - \frac{1}{2} )}^{2}} ) ] & ( 43 )\end{matrix}$$

The expression may be further simplified by defining the following:

$$\{ \begin{matrix}α = {( \frac{\frac{πϵ}{N} cos \frac{π v}{N} - sin \frac{π v}{N}}{{sin}^{2} \frac{π v}{N}} )}^{2} \\ β = {( \frac{\frac{πϵ}{N} cos \frac{π v}{N} + sin \frac{π v}{N}}{{sin}^{2} \frac{π v}{N}} )}^{2}\end{matrix} \qquad ( 44 )$$

Using the definition in (44)

$${P}_{ICI , k} = \frac{{E}_{s}}{{N}^{2}} {sin}^{2} ( πϵ ) {\sum }_{m = 0 , \\ m \neq k}^{N - 1} 𝔼 [ ( α {\vert {H}_{m , 1} \vert}^{2} + β {\vert {\overline{H}}_{m , 2} \vert}^{2} + 2 {H}_{m , 1} {\overline{H}}_{m , 2} \frac{{( \frac{πϵ}{N} )}^{2} {cos}^{2} \frac{π v}{N} - {sin}^{2} \frac{π v}{N}}{{sin}^{4} \frac{π v}{N}} ) ] \qquad ( 45 )$$

For small values of ∈,

$${( \frac{πϵ}{N} )}^{2} \approx 0$$

and this, the final derivation of ICI power may be obtained as follows.

$$\begin{matrix}\begin{matrix}{P}_{ICI , k} = \frac{{E}_{s}}{{N}^{2}} {sin}^{2} ( πϵ ) {\sum }_{m = 0 , \\ m \neq k}^{N - 1} 𝔼 [ ( α {\vert {H}_{m , 1} \vert}^{2} + β {\vert {\overline{H}}_{m , 2} \vert}^{2} - 2 {csc}^{2} \frac{π v}{N} {H}_{m , 1} {\overline{H}}_{m , 2} ) ] \\ = \frac{{E}_{s}}{{N}^{2}} {sin}^{2} ( πϵ ) {\sum }_{m = 0 , \\ m \neq k}^{N - 1} \end{matrix} & ( 46 ) \\ [ α {R}_{{H}_{1}} ( m , m ) + β {R}_{{\overline{H}}_{2}} ( m , m ) - 2 {csc}^{2} \frac{π v}{N} {R}_{{H}_{1} {\overline{H}}_{\dot{2}}} ( m , m ) ] & ( 47 )\end{matrix}$$

Based on the results obtained in (34) and (47) and the definition of SIR in (25), the ratio of the desired signal's power to the ICI power may be computed as follows.

$${SIR}_{k} \approx {( \frac{N}{πϵ} )}^{2} [ {R}_{{H}_{1}} ( k , k ) + {R}_{{\overline{H}}_{2}} ( k , k ) + 2 Re \{ {R}_{{H}_{1} {\overline{H}}_{2}} ( k , k ) \} ] \text{/} {\sum }_{m = 0 , \\ m \neq k}^{N - 1} [ α {R}_{{H}_{1}} ( m , m ) + β {R}_{{\overline{H}}_{2}} ( m , m ) - 2 {csc}^{2} \frac{π v}{N} {R}_{{H}_{1} {\overline{H}}_{\dot{2}}} ( m , m ) ] \qquad ( 48 )$$

where α and β are defined in (44), the autocorrelations and cross correlation functions are defined in (31) and (32), csc θ=1/sin θ and v=m−k.

The total SIR may be calculated as a summation of SIR for each subcarrier. SIR simulations for both ST and STPC are provided in the next section.

$$SIR = {\sum }_{k = 0}^{N - 1} {SIR}_{k} . \qquad ( 49 )$$

### Simulation Results

SIR computation requires finding the autocorrelations and cross correlation functions according to (48), namely, R_{H}_{₁}(k, m), R_{H}_{₂}(k,m), R_{H}_{₁}_{H̅}_{₂}(k, m), and R_{H}_{₁}_{H}_{₂}_{*}(k,m).

These are N×N matrices, where element (k,m) represents autocorrelation or cross correlation of the kth and mth subcarriers as defined in (31) and (32). In the simulations, the focus is on a few configurations, namely, protective-earth-phase (PEP) (i.e., D3 to S1), phase-neutral-common-mode (PNCM) (i.e., D1 to S4) and phase-neutral-neutral (PNN) (i.e., D1 to S2).

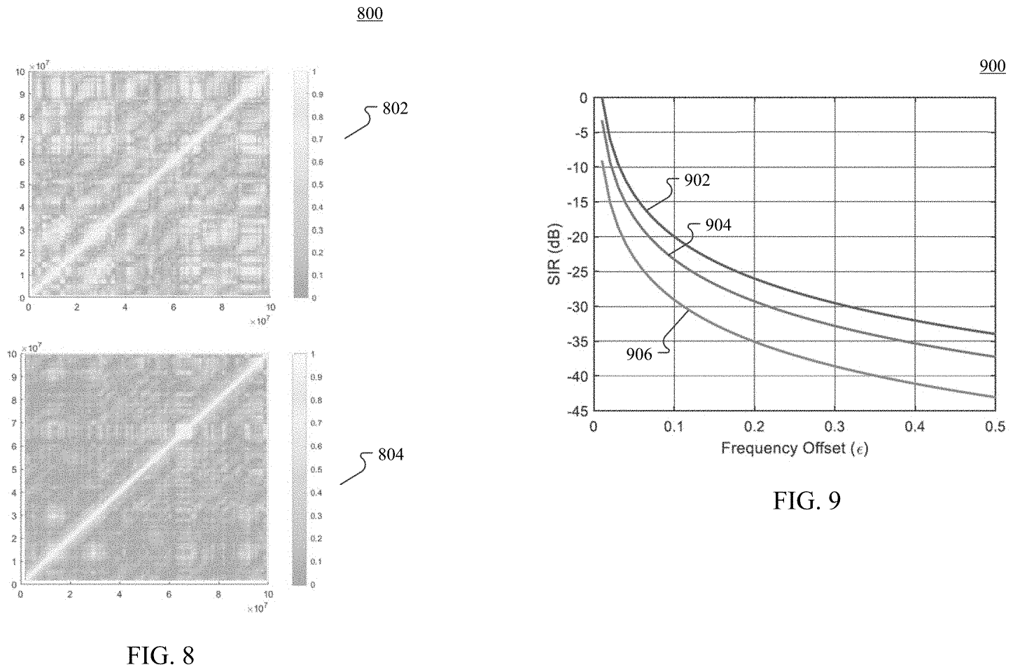

As an example, FIG. 8 depicts plots of autocorrelation for two different MIMO paths, PEP and PNCM. The autocorrelation between 512 subcarriers of PEP is shown in subplot 802, and PNCM is shown in subplot 804.

FIG. 9 is a plot of a signal-to-interference ratio comparison for STPC-OFDM with various subcarriers. Using (48) and (49), the SIR may be evaluated for STPC-OFDM versus a normalized frequency offset ∈ in MIMO-PLC. Here, STPC-OFDM for PEP-PNCM with 128, 512, and 1024 subcarriers are considered. In particular, PEP-PNCM, STPC-OFDM with N=1024 is shown as line 902; PEP-PNCM, STPC-OFDM with N=512 is shown as line 904; and PEP-PNCM, STPC-OFDM, N=128 is shown as line 906. As can be seen in FIG. 9, SIR (y-axis) degrades with higher level of frequency offset (x-axis), and higher number of subcarriers translates to robustness against synchronization issues.

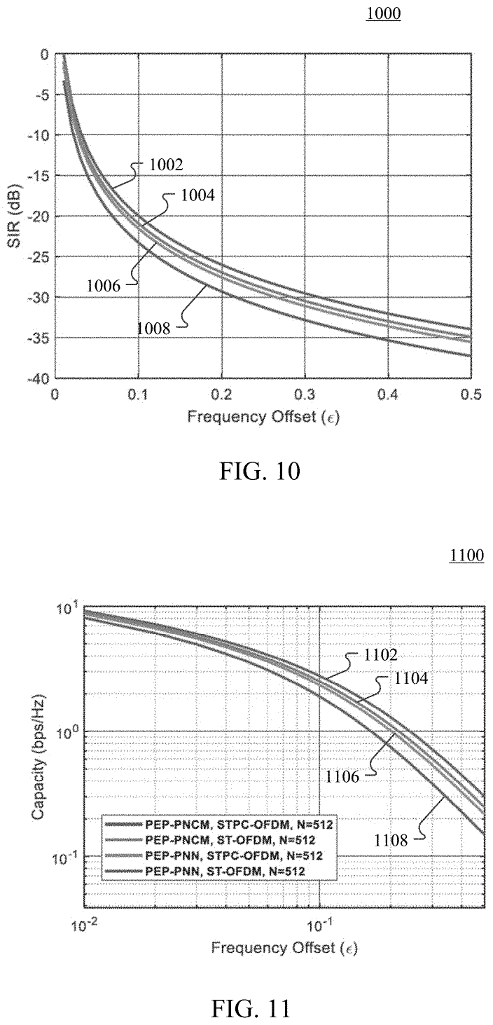

FIG. 10 is a plot of a signal-to-interference ratio comparison between STPC-OFDM and ST-OFDM. In FIG. 10, the effect of correlation is demonstrated as a function of frequency offset. The operating frequency is 100 MHz and PEP-PNCM and PEP-PNN are considered for different level of correlation between their branches. In FIG. 10, PEP-PNCM, STPC-OFDM, N=512 is shown as line 1002; PEP-PNCM, ST-OFDM, N=512 is shown as line 1004; PEP-PNN, STPC-OFDM, N=512 is shown as line 1006; and PEP-PNN, ST-OFDM, N=512 is shown as line 1008. Note that the path with less correlation, i.e., PEP-PNCM (shown in FIG. 3) demonstrates more resilience against the frequency offset. In contrast, the path with higher correlation, i.e., PEP-PNN (shown in FIG. 3), exhibits less resilience. In the simulation depicted in FIG. 10, both ST-OFDM and STPC-OFDM in PEP-PNCM have better SIR compared to that of PEP-PNN. In both scenarios, STPC-OFDM is better than ST-OFDM.

FIG. 11 is a plot of channel capacity for varying frequency offset in STPC-OFDM and ST-OFDM with 512 subcarriers at 100 MHz. In FIG. 11, PEP-PNCM, STPC-OFDM, N=512 is shown as line 1102; PEP-PNCM, ST-OFDM, N=512 is shown as line 1104; PEP-PNN, STPC-OFDM, N=512 is shown as line 1106; and PEP-PNN, ST-OFDM, N=512 is shown as line 1108. The STPC-PEP-PNCM-OFDM and the ST-PEP-PNN-OFDM has the highest and lowest channel capacity, respectively. SIR is adopted in the formula of channel capacity since the main interest is the impact of ICI on the channel capacity, i.e.,

C=log₂(1+SIR) (50)

where C is the channel capacity in bps/Hz. As shown in FIG. 10, SIR is a function of frequency offset. Therefore, in turn, the channel capacity is also a function of frequency offset reflected on SIR according to equation (50).

For BER performance, the realization of PLC channels accounts for correlation between different paths in MIMO-PLC. Regarding modulation order and scheme, QPSK mapping is implemented, although other order and schemes may be used. Noise parameters include A=5.8 and Γ=0.1, as described above in reference to the MIMO PLC channel model. Where A is the impulsive index and Γ is the background-to-impulse noise ratio. For ST-OFDM and STPC-OFDM 2×2, the following paths have been considered for evaluating the performance of the system.

In the first scenario, the upper branch is between phase and protective-earth on a Delta-style coupler and phase at the receiver on a Star-style coupler, which is denoted as PEP. The lower branch is between phase-neutral on the Delta-style coupler and neutral on the Star-style coupler, which is denoted as PNN. Therefore, this scenario with the upper branch as PEP and the lower branch as PNN is abbreviated as PEP-PNN in the simulations described herein.

The second scenario, the upper branch is between phase and protective-earth with the Delta-style coupler on the transmitter and phase with the Star-style coupler on the receiver, denoted as PEP. The lower branch has phase-neutral on the transmitter and common mode on the Star-style coupler at the receiver, denoted as PNCM. The notation for this case is PEP-PNCM.

In the simulations described herein, Wash-Hadamard orthogonal coding is applied at the transmitter and receiver in order to improve the performance of the system under the presence of AIGN. As described above with respect to the MIMO PLC channel model, there is higher correlation between PEP-PNN versus PEP-PNCM branches. In the subsequent figures, the effect of the channel correlations will be described.

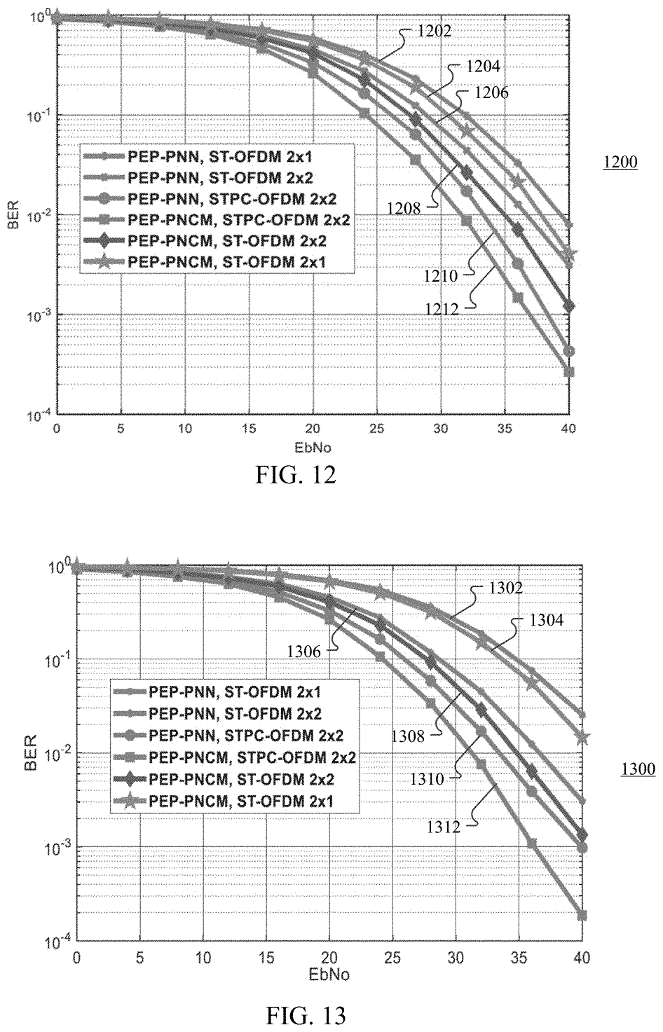

FIG. 12 is a plot of MIMO PLC BER performance comparison for two scenarios: PEP-PNN and PEP-PNCM. Independent noise in each path is considered, and 1024-point FFT/IFFT is used. Noise correlation between two branches is considered to be zero (independent). In FIG. 12, PEP-PNN, ST-OFDM 2×1 is depicted as line 1202; PEP-PNN, ST-OFDM 2×2 is depicted as line 1206; PEP-PNN, STPC-OFDM 2×2 is depicted as line 1210; PEP-PNCM, STPC-OFDM 2×2 is depicted as line 1212; PEP-PNCM, ST-OFDM 2×2 is depicted as line 1208; and PEP-PNCM, ST-OFDM 2×1 is depicted as line 1204.

The scenario with less correlation between branches demonstrates better BER performance in the presence of impulsive and background noise. Here, STPC-OFDM 2×2 for PEP-PNCM has the best BER performance, where channel correlation is the least between the two branches. The second is STPC-OFDM 2×2 for PEP-PNN where higher correlation exists between the two branches. The same order follows for ST-OFDM 2×2 and at the end, the worst BER performance may be seen for ST-OFDM 2×1 with PEP-PNN.

FIG. 13 is another plot of MIMO-PLC BER performance comparison for two coupling scenarios. FIG. 13 is similar to FIG. 12, with the difference of FIG. 12 depicting the case where noise correlation between the two branches is considered to be zero (independent), whereas FIG. 13 depicts the case of 100% correlation between the channel AIGN noise in the two branches. In FIG. 13, PEP-PNN, ST-OFDM 2×1 is depicted as line 1302; PEP-PNN, ST-OFDM 2×2 is depicted as line 1306; PEP-PNN, STPC-OFDM 2×2 is depicted as line 1310; PEP-PNCM, STPC-OFDM 2×2 is depicted as line 1312; PEP-PNCM, ST-OFDM 2×2 is depicted as line 1308; and PEP-PNCM, ST-OFDM 2×1 is depicted as line 1304.

As shown in FIG. 13, the best BER performance may be seen for the STPC-OFDM 2×2 in PEP-PNCM and the worst performance belongs to ST-OFDM 2×1 in PEP-PNN. The order of BER performance is similar for both scenarios demonstrated in FIGS. 12 and 13. The effect of noise correlation on the performance is exhibited, in particular, on the BER performance of ST-OFDM 2×1. In this case, the BER performance suffers considerably in comparison to the scenario where noise is independent. However, noise correlation does not change the BER performance of the system for neither ST-OFDM 2×2 nor STPC-OFDM 2×2 due to diversity.

### Example Computer System Implementation

Each of couplers 200 and 300 and transceivers 500, 600, and 700 may be implemented in hardware, or hardware combined with software and/or firmware. For example, couplers 200 and 300 and transceivers 500, 600, and 700, and/or their components may be implemented as computer program code/instructions configured to be executed in one or more processors and stored in a computer readable storage medium. Alternatively, couplers 200 and 300 and transceivers 500, 600, and 700, and/or their components may be implemented as hardware logic/electrical circuitry.

For instance, in an embodiment, one or more, in any combination, of couplers 200 and 300 and transceivers 500, 600, and 700 may be implemented together in a system-on-a-chip (SoC). The SoC may include an integrated circuit that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

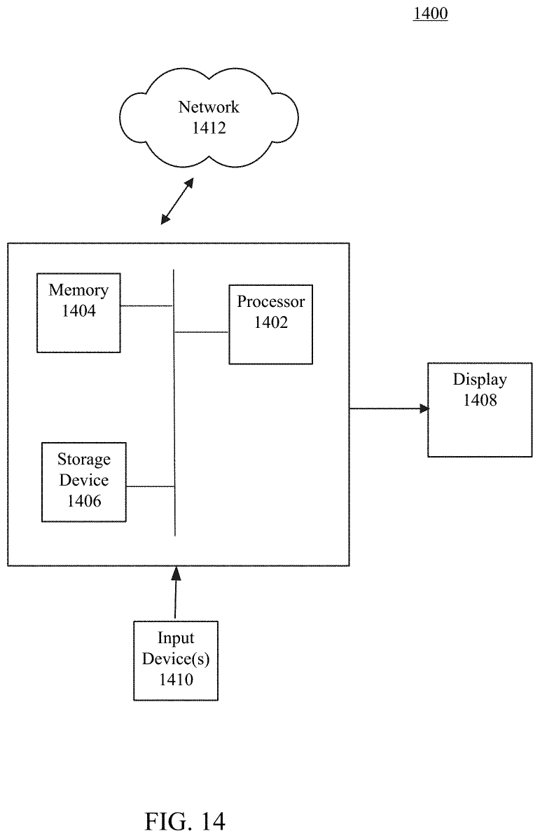

FIG. 14 is a block diagram of an example computer system in which embodiments may be implemented. The description of computing device 1400 is provided for purposes of illustration, and is not intended to be limiting. Embodiments may be implemented in further types of computer systems, as would be known to persons skilled in the relevant art(s).

As shown in FIG. 14, computing device 1400 includes processor 1402, memory 1404, and storage device 1406 coupled together via a bus.

Processor 1402 may be referred to as a processor circuit or a processing unit. Processor 1402 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor 1402 may execute program code stored in a computer readable medium, such as program code of an operating system, an application program, and other programs.

Memory 1404 includes any system memory, for example, read only memory (ROM) and random access memory (RAM) and may store a basic input/output system (e.g., BIOS).

Storage device 1406 may include any of a hard disk drive, a magnetic disk drive, an optical disk drive, a removable optical disk (e.g., CD ROM, DVID ROM), a flash memory card, a digital video disk, RAMs, ROMs, or other hardware storage media. Storage device 1406 and its associated computer readable media provide nonvolatile storage of computer-readable instructions, data structures, program modules and other data for computing device 1400.

A number of program modules may be stored on memory 1404 and/or storage device 1406. These programs include an operating system, an application program, other programs, and program data. Such an application program or other programs may include, for example, computer program logic (e.g., computer program code or instructions) for implementing transceivers 500, 600 and 700, and/or further embodiments described herein.

A user may enter commands and information into the computing device 1400 through input devices 1410 such as a keyboard and a pointing device. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 1402 through a serial port interface that is coupled to the bus, but may be connected by other interfaces, such as a parallel port, game port, or a universal serial bus (USB).

A display 1408 is also connected to the bus via an interface, such as a video adapter. Display 1408 may be external to, or incorporated in computing device 1400. Display 1408 may display information, as well as being a user interface for receiving user commands and/or other information (e.g., by touch, finger gestures, virtual keyboard, etc.). In addition to display 1408, computing device 1400 may include other peripheral output devices (not shown) such as speakers and printers.

Computing device 1400 is connected to a network 1412 (e.g., the Internet) through an adaptor or network interface, a modem, or other means for establishing communications over the network.

As used herein, the terms “computer program medium,” “computer-readable medium,” and “computer-readable storage medium” are used to refer to physical hardware media such as the hard disk associated with storage device 1406. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

### CONCLUSION

While various embodiments of the disclosed subject matter have been described above, it should be understood that they have been presented by way of example only, and not limitation. Various modifications and variations are possible without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. An orthogonal frequency division multiplexing system for multiple-input multiple-output power line communications, comprising:
a space-time encoder configured to encode a sequence of data symbols to generate a first code word and a second code word;
a first transmitter inverse transform block configured to inverse transform the first code word into an inverse transformed first code word;
a second transmitter inverse transform block configured to inverse transform the second code word into an inverse transformed second code word;
a first cyclic prefix adder configured to add a first cyclic prefix to the inverse transformed first code word to generate a first signal for transmitting over a first path of a power line channel;
a second cyclic prefix adder configured to add a second cyclic prefix to the inverse transformed second code word to generate a second signal for transmitting over a second path of the power line channel;
a cyclic prefix remover configured to remove the first cyclic prefix from the first signal received via the first path of the power line channel to generate a first resultant signal, and to remove the second cyclic prefix from the second signal received via the second path of the power line channel to generate a second resultant signal;
a receiver forward transform block configured to demodulate the first resultant signal and second resultant signal to respectively generate a first received signal and a second received signal;
a combiner configured to combine the first received signal and the second received signal to form a combined received signal; and
a detector configured to detect the data symbols from the combined received signal to form an output signal.

2. The system of claim 1, wherein the first transmitter inverse transform block and the second transmitter inverse transform block are connected in parallel.

3. The system of claim 1, further comprising:
a first coupler configured to enable the first signal and the second signal to be respectively transmitted via the first path and the second path of the power line channel; and
a second coupler configured to enable the first signal and the second signal to be respectively received via the first path and the second path of the power line channel.

4. The system of claim 3, wherein the first coupler comprises a delta coupler; and
wherein the delta coupler is configured to enable the first signal to be transmitted via a phase-protective earth port and the second signal to be transmitted via a phase-neutral port.

5. The system of claim 3, wherein the second coupler comprises a star coupler; and
wherein the star coupler is configured to enable the first signal to be received via a phase port and the second signal to be received via a neutral port.

6. The system of claim 3, wherein the second coupler comprises a star coupler; and
wherein the star coupler is configured to enable the first signal to be received via a phase port and the second signal to be received via a common mode port.

7. An orthogonal frequency division multiplexing system for multiple-input multiple-output power line communications, comprising:
a space-time encoder configured to encode a sequence of data symbols to generate a first code word and a second code word;
a first transmitter inverse transform block configured to inverse transform the first code word into an inverse transformed first code word;
a second transmitter inverse transform block configured to inverse transform the second code word into an inverse transformed second code word;
a first cyclic prefix adder configured to add a first cyclic prefix to the inverse transformed first code word to generate a first signal for transmitting over a first path of a power line channel;
a second cyclic prefix adder configured to add a second cyclic prefix to the inverse transformed second code word to generate a second signal for transmitting over a second path of the power line channel;
a first cyclic prefix remover configured to remove the first cyclic prefix from the first signal received via the first path of the power line channel to generate a first resultant signal;
a second cyclic prefix remover configured to remove the second cyclic prefix from the second signal received via the second path of the power line channel to generate a second resultant signal;
a receiver first forward transform block configured to forward transform the first resultant signal into a first received signal;
a receiver second forward transform block configured to forward transform the second resultant signal into a second received signal;
a combiner configured to combine the first received signal and the second received signal to form a combined received signal; and
a detector configured to detect the data symbols from the combined received signal to form an output signal.

8. The system of claim 7, wherein the first transmitter inverse transform block and the second transmitter inverse transform block are connected in parallel; and
wherein the receiver first forward transform block and the receiver second forward transform block are connected in parallel.

9. The system of claim 7, further comprising:
a first coupler configured to enable the first signal and the second signal to be respectively transmitted via the first path and the second path of the power line channel; and
a second coupler configured to enable the first signal and the second signal to be respectively received via the first path and the second path of the power line channel.

10. The system of claim 9, wherein the first coupler comprises a delta coupler; and
wherein the delta coupler is configured to enable the first signal to be transmitted via a phase-protective earth port and the second signal to be transmitted via a phase-neutral port.

11. The system of claim 9, wherein the second coupler comprises a star coupler; and
wherein the star coupler is configured to enable the first signal to be received via a phase port and the second signal to be received via a neutral port.

12. The system of claim 9, wherein the second coupler comprises a star coupler; and
wherein the star coupler is configured to enable the first signal to be received via a phase port and the second signal to be received via a common mode port.

13. An orthogonal frequency division multiplexing system for multiple-input multiple-output power line communications, comprising:
a space-time encoder configured to encode a sequence of data symbols to generate a first code word and a second code word;
a transmitter inverse transform block configured to inverse transform the first code word into an inverse transformed first code word;
a transmitter forward transform block configured to forward transform the second code word into a forward transformed second code word;
a first cyclic prefix adder configured to add a first cyclic prefix to the inverse transformed first code word to generate a first signal for transmitting over a first path of a power line channel;
a second cyclic prefix adder configured to add a second cyclic prefix to the forward transformed second code word to generate a second signal for transmitting over a second path of the power line channel;
a first cyclic prefix remover configured to remove the first cyclic prefix from the first signal received via the first path of the power line channel to generate a first resultant signal;
a second cyclic prefix remover configured to remove the second cyclic prefix from the second signal received via the second path of the power line channel to generate a second resultant signal;
a receiver forward transform block configured to forward transform the first resultant signal into a first received signal;
a receiver inverse transform block configured to inverse transform the second resultant signal into a second received signal;
a combiner configured to combine the first received signal and the second received signal to form a combined received signal; and
a detector configured to detect the data symbols from the combined received signal to form an output signal.

14. The system of claim 13, wherein the transmitter inverse transform block and the transmitter forward transform block are connected in parallel; and
wherein the receiver forward transform block and the receiver inverse transform block are connected in parallel.

15. The system of claim 13, further comprising:
a first coupler configured to enable the first signal and the second signal to be respectively transmitted via the first path and the second path of the power line channel; and
a second coupler configured to enable the first signal and the second signal to be respectively received via the first path and the second path of the power line channel.

16. The system of claim 15, wherein the first coupler comprises a delta coupler; and
wherein the delta coupler is configured to enable the first signal to be transmitted via a phase-protective earth port and the second signal to be transmitted via a phase-neutral port.

17. The system of claim 15, wherein the second coupler comprises a star coupler; and
wherein the star coupler is configured to enable the first signal to be received via a phase port and the second signal to be received via a neutral port.

18. The system of claim 15, wherein the second coupler comprises a star coupler; and
wherein the star coupler is configured to enable the first signal to be received via a phase port and the second signal to be received via a common mode port.
